(19) United States
(12) Patent Application Publication
(10) Pub. No.: US 2021/0011795 A1
(43) Pub. Date: Jan. 14, 2021

(54) COMPUTER SYSTEM, CONTROL METHOD, AND RECORDING MEDIUM

(71) Applicant: HITACHI, LTD., Tokyo (JP)

(72) Inventors: Tomoyuki KAMAZUKA, Tokyo (JP); Kazushi NAKAGAWA, Tokyo (JP); Kazunari TANAKA, Tokyo (JP)

(73) Assignee: HITACHI, LTD., Tokyo (JP)

(21) Appl. No.: 16/813,846

(22) Filed: Mar. 10, 2020

(30) Foreign Application Priority Data
Jul. 10, 2019 (JP) 2019-128505

(51) Int. Cl. G06F 11/07

(52) U.S. Cl. CPC G06F 11/0751; G06F 11/0793; G06F 11/0727

(57) ABSTRACT

An FPGA includes a CRAM that records configuration data for defining a circuit configuration, a main circuit unit of which the circuit configuration is determined according to the configuration data, and an error detection unit that executes memory check processing of detecting whether or not any error is present in the configuration data. A control unit causes the main circuit unit to sequentially execute a plurality of sub-processing steps obtained by segmenting predetermined processing upon receiving a query requesting execution of the predetermined processing to execute the predetermined processing and enables the error detection unit to execute the memory check processing for each of the sub-processing steps.

### BACKGROUND

The present disclosure relates to a computer system, a control method, and a program.

A computer system having a programmable device of which the internal circuit configuration can be rewritten is known. Some programmable device, such as FPGA (Field-Programmable Gate Array), includes a configuration memory (CRAM: Configuration Random Access Memory) that stores configuration data (hardware information) that defines an internal circuit configuration.

Various failures may occur in the programmable device. For example, a soft error that involves bit inversion of configuration data written to a configuration memory may occur due to radioactive rays. Due to this, detection processing for detecting failures may be performed in a computer system having a programmable device. However, there is a problem that failure detection incurs a considerable amount of time.

WO 2017/002157 and Japanese Patent Application Publication No. 2016-167669 disclose a technique for decreasing the time required for detecting soft errors.

For example, WO 2017/002157 discloses a computer system including a storage apparatus having an FPGA and a computer. The computer transmits an arithmetic command to the storage apparatus and after that, receives an execution result of the arithmetic command from the storage apparatus. The computer instructs the FPGA to detect a soft error when the number of execution results of the arithmetic command reaches a predetermined value.

Japanese Patent Application Publication No. 2016-167669 discloses a technique of checking an error in target configuration data corresponding to an error checking target circuit among pieces of configuration data in a configuration memory.

### SUMMARY

In the technique disclosed in WO 2017/002157, because a soft error is not detected until the number of execution results of the arithmetic command reaches a predetermined value, there is a problem with reliability. Moreover, in the technique disclosed in Japanese Patent Application Publication No. 2016-167669, because a soft error is detected in a portion of the configuration data, there is a problem with reliability.

An object of the present disclosure is to provide a computer system, a control method, and a program capable of securing reliability while decreasing the time required for detecting failures.

A computer system according to an aspect of the present disclosure is a computer system including: a programmable device including a memory that records configuration data for defining a circuit configuration, a main circuit unit of which the circuit configuration is determined according to the configuration data, and an error detection unit that executes memory check processing of detecting whether or not any error is present in the configuration data; and a control unit is configured to cause the main circuit unit to sequentially execute a plurality of sub-processing steps obtained by segmenting predetermined processing upon receiving a query requesting execution of the predetermined processing to execute the predetermined processing and enable the error detection unit to execute the memory check processing for each of the sub-processing steps.

According to the present invention, it is possible to secure reliability while decreasing the time required for detecting failures.

Other objects, configuration, and advantageous effects other than those described above will be understood from the description of the embodiment of the invention.

### BRIEF DESCRIPTION OF THE DRAWINGS

FIG. 1 is a diagram illustrating a configuration of a computer system according to an embodiment of the present disclosure;

FIG. 2 is a diagram illustrating an example of a state management table;

FIG. 3 is a diagram illustrating an example of a history management table;

FIG. 4 is a diagram for describing an example of second failure detection processing;

FIG. 5 is a flowchart for describing an example of an operation of the computer system related to first failure detection processing and second failure detection processing;

FIG. 6 is a flowchart for describing an example of an operation of the computer system related to third failure detection processing;

FIG. 7 is a flowchart for describing an operation of the operation of the computer system related to the first failure detection processing and the second failure detection processing in more detail;

FIG. 8 is a flowchart for describing an operation of the operation of the computer system related to the third failure detection processing in more detail;

FIG. 9 is a diagram for describing the degree of improvement in reliability and the degree of influence on performance by failure detection processing; and

FIG. 10 is a diagram illustrating an example of setting information indicating failure detection processing to be executed.

### DETAILED DESCRIPTION OF THE EMBODIMENT

Hereinafter, an embodiment of the present disclosure will be described with reference to the drawings. The following descriptions and drawings are examples for describing the present disclosure, and omissions and simplifications are made appropriately for the sake of clear explanation. The present disclosure can be implemented in various other forms. The respective components may be provided singly or plurally unless particularly stated otherwise. Moreover, the positions, sizes, shapes, ranges, and the like of the components illustrated in the drawings do not sometimes represent the actual positions, size, shapes, ranges, and the like in order to facilitate understanding of the present disclosure. Therefore, the present disclosure is not restricted to the positions, sizes, shape, ranges, and the like illustrated in the drawings.

In the following description, when identification information is described, expressions such as “identification information”, “identifier”, “name”, “ID”, and “number” are used, but these expressions can be replaced with each other.

In the following description, there may be cases in which processing is described using a “program” as the subject. However, because the determined processing is performed using a storage resource (for example, a memory) and/or an interface device (for example, a communication port) appropriately when the program is executed by a processor (for example, a CPU (Central Processing Unit) or a GPU (Graphics Processing Unit)), the processor may be also used as the subject of the processing. Similarly, the subject of processing performed by executing a program may be a controller, an apparatus, a system, a computer, or a node having a processor. The subject of processing performed by executing a program may be an arithmetic unit and may include a dedicated circuit (for example, an FPGA and an ASIC (Application Specific Integrated Circuit)) that performs specific processing.

The program may be installed from a program source to an apparatus such as a computer. The program source may be a program distribution server or a computer-readable storage medium. When the program source is a program distribution server, the program distribution server may include a processor and a storage resource that stores a distribution target program, and the processor of the program distribution server may distribute the distribution target program to another computer. Moreover, in the following description, two or more programs may be implemented as one program, and one program may be implemented as two or more programs.

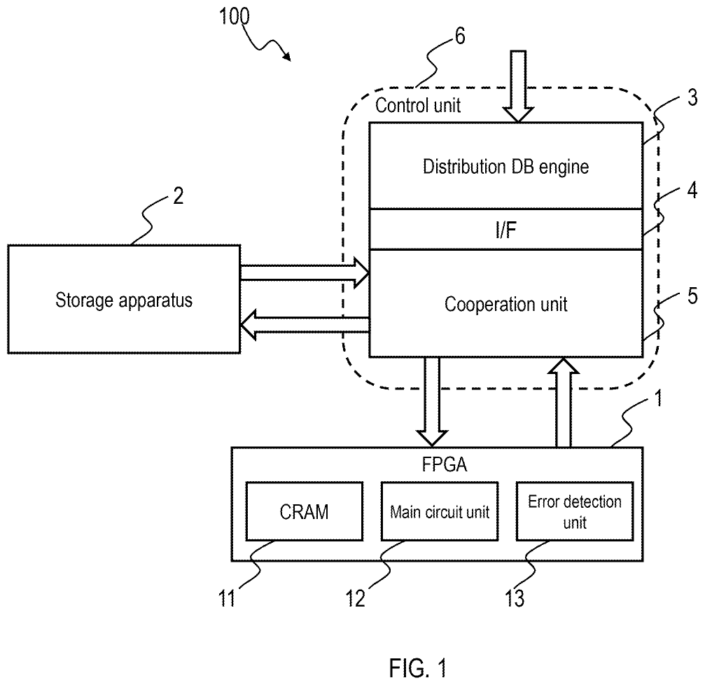

FIG. 1 is a diagram illustrating a configuration of a computer system according to an embodiment of the present disclosure. A computer system 100 illustrated in FIG. 1 includes an FPGA 1, a storage apparatus 2, a distribution DB (Data Base) engine 3, an I/F 4, and a cooperation unit 5.

The FPGA 1 is a programmable device of which the internal circuit configuration (the logical configuration) can be rewritten. In the present embodiment, the FPGA 1 is used as an accelerator of storage processing, which is processing on the storage apparatus 2. The FPGA 1 may have a configuration in which a plurality of IP cores (Intellectual Property Cores) which are circuit blocks (functional blocks) are combined.

The FPGA 1 includes a CRAM 11, a main circuit unit 12, and an error detection unit 13. The CRAM 11 is a memory that records configuration data for defining a circuit configuration. The main circuit unit 12 is a circuit unit of which the circuit configuration is determined according to the configuration data recorded in the CRAM 11. The error detection unit 13 executes CRAM check processing which is memory check processing of detecting whether or not a failure (for example, a soft error) is present in the CRAM 11 (more specifically, whether or not any error is present in the configuration data recorded in the CRAM 11). The CRAM check processing includes correction processing of correcting an error in the configuration data when the error is detected. In the present embodiment, cyclic check that involves going round all areas of the CRAM 11 to detect the presence of an error in all pieces of configuration data is performed as the CRAM check processing, and the error detection unit 13 performs the CRAM check processing repeatedly.

The storage apparatus 2 stores various types of data. In the present embodiment, the storage apparatus 2 stores a database of a Parquet format and may store databases of other formats.

The distribution DB engine 3, the I/F 4, and the cooperation unit 5 form a control unit 6 that performs storage processing (for example, reading, writing, and filtering of data) with respect to the storage apparatus 2 using the FPGA 1. The control unit 6 includes a processor such as a CPU (Central Processing Unit) and reads a program recorded on a recording medium (not illustrated) and executes the read program to execute the storage processing. The program is software, middleware, drivers, and the like for example.

The distribution DB engine 3 is implemented, for example, in “Hadoop” capable of processing a large volume of data (particularly, “SQL-on-Hadoop” compatible with queries described in SQL). Upon receiving a query requesting execution of storage processing from a high-level unit (not illustrated) or the like, the distribution DB engine 3 determines whether request processing requested to be executed by the query is FPGA processing that is predetermined processing to be performed by the FPGA 1. When the request processing is FPGA processing, the distribution DB engine 3 outputs a command corresponding to the received query to the cooperation unit 5 via the I/F 4. Moreover, the distribution DB engine 3 receives a processing result of the FPGA processing by the FPGA 1 from the cooperation unit 5 via the I/F 4 and controls the database stored in the storage apparatus 2 according to the processing result.

The I/F 4 relays data between the distribution DB engine 3 and the cooperation unit 5. The I/F 4 is implemented by a plug-in, for example. The I/F 4 converts the command from the distribution DB engine 3 to a format corresponding to the cooperation unit 5 and issues the command to the cooperation unit 5. Moreover, the I/F 4 converts the processing result from the cooperation unit 5 to a format corresponding to the distribution DB engine 3 and outputs the processing result to the distribution DB engine 3.

The cooperation unit 5 controls the FPGA 1 in cooperation with the distribution DB engine 3. Specifically, the cooperation unit 5 causes the FPGA 1 (specifically, the main circuit unit 12) to execute the FPGA processing corresponding to the command from the distribution DB engine 3, acquires the processing result from the FPGA 1, and transmits the processing result to the distribution DB engine 3. The cooperation unit 5 is implemented by middleware and a driver for the FPGA 1, for example.

The cooperation unit 5 executes failure detection processing for detecting a failure in the FPGA 1. The failure in the FPGA 1 includes an intermittent failure occurring temporarily and a permanent failure lasting permanently. The intermittent failure includes a failure (a soft error) of the CRAM 11 in the FPGA 1. The failure detection processing includes first failure detection processing for detecting whole intermittent failure, second failure detection processing for detecting a failure of the CRAM 11, and third failure detection processing for detecting a permanent failure.

In the first failure detection processing, the cooperation unit 5 causes the FPGA 1 to execute FPGA processing corresponding to the command from the distribution DB engine 3 repeatedly twice and compares the execution results to detect the presence of an intermittent failure in the FPGA 1. In this case, the cooperation unit 5 determines that an intermittent failure is not present (has not occurred) when the execution results match and determines that an intermittent failure is present (has occurred) when the execution results do not match. When an intermittent failure is present, the cooperation unit 5 may cause the FPGA processing to be executed twice repeatedly.

In the second failure detection processing, the cooperation unit 5 causes the error detection unit 13 of the FPGA 1 to execute CRAM check processing when causing the FPGA 1 to execute FPGA processing to detect the presence of a failure of the CRAM 11 (that is, the presence of an error in the configuration data recorded in the CRAM 11). In this case, the cooperation unit 5 divides the command from the distribution DB engine 3 into a plurality of subcommands and issues the subcommands sequentially to cause the FPGA 1 to execute a plurality of sub-processing steps obtained by segmenting the FPGA processing. The cooperation unit 5 enables CRAM check processing for each sub-processing steps.

In the third failure detection processing, the cooperation unit 5 periodically performs health check processing of checking whether circuits in the FPGA 1 are normal.

The cooperation unit 5 may not execute all the first to third failure detection processing. The failure detection processing executed by the cooperation unit 5 may be set by a user who uses the computer system 100.

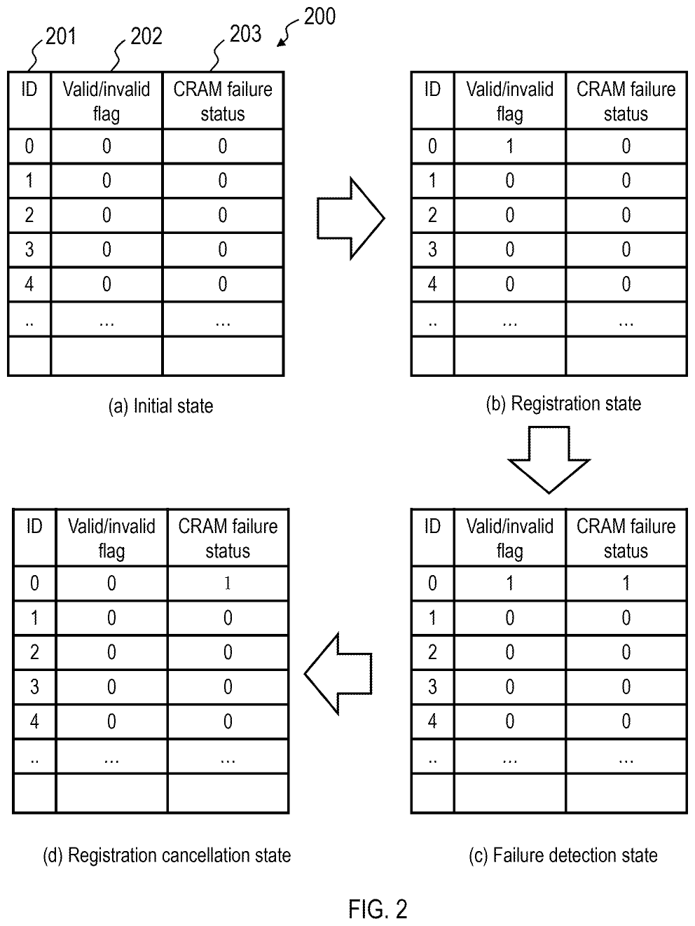

FIG. 2 is a diagram illustrating an example of a state management table managed by the cooperation unit 5 in the second failure detection processing and a state transition thereof. The state management table is recorded in a recording medium (not illustrated) or the like, for example, and is updated by the cooperation unit 5 appropriately.

A state management table 200 illustrated in FIG. 2 includes an ID 201, a valid/invalid flag 202, and a CRAM failure status 203. The ID 201 is a field for storing an ID which is identification information for identifying a subcommand. The valid/invalid flag 202 is a field for storing a valid/invalid flag indicating whether the second failure detection processing is valid or not. The valid/invalid flag is “1” when it is valid and “0” when it is invalid. The CRAM failure status 203 is a field for recording a CRAM failure status indicating whether a failure has occurred in the CRAM 11. The CRAM failure status is “1” when a failure has occurred and “0” when a failure has not occurred.

In an initial state (a) in which a subcommand is not issued, the valid/invalid flag and the CRAM failure status are “0” for all IDs. After that, when a subcommand having the ID of “0” is issued, the cooperation unit 5 changes the value of the valid/invalid flag corresponding to the ID of “0” to “1” and causes the error detection unit 13 to execute CRAM check processing (see registration state (b)). When a failure of the CRAM 11 is detected in the CRAM check processing, the cooperation unit 5 changes the value of the CRAM failure status corresponding to the ID of “0” to “1” (see failure detection state (c)). Furthermore, when the sub-processing step corresponding to the subcommand ends, the cooperation unit 5 returns the valid/invalid flag corresponding to the ID of “0” to “0” (see registration cancellation state (d)). When a failure of the CRAM 11 is not detected and a sub-processing step ends after a subcommand is issued, the failure detection state (c) is skipped and the registration state (b) transitions to the registration cancellation state (d). In this case, the value of the CRAM failure status is “0”.

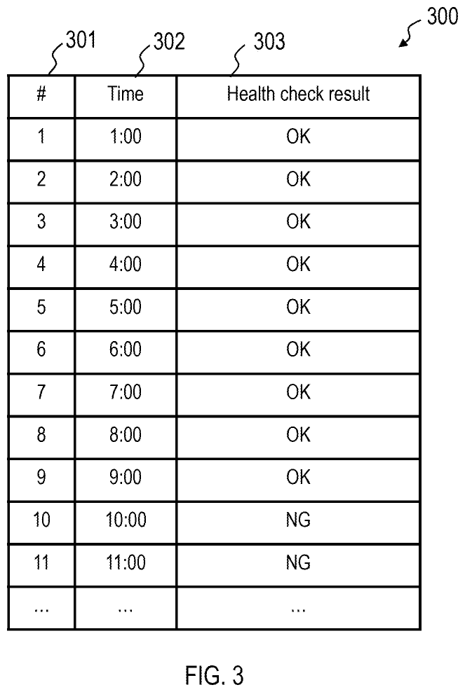

FIG. 3 is a diagram illustrating an example of a history management table managed by the control unit 6 in the third failure detection processing. The history management table is recorded on a recording medium (not illustrated) or the like, for example, and is updated by the cooperation unit 5 appropriately.

A history management table 300 illustrated in FIG. 3 includes a number (#) 301, a time 302, and a health check result 303. The number 301 is a field for recording an identification number for identifying health check processing. The time 302 is a field for recording an execution time which is the time when the health check processing was executed. In the example of FIG. 3, the health check processing is performed every hour. The health check result 303 is a field for storing a health check result which is the processing result of health check processing. The health check result indicates whether a permanent failure has been detected. Specifically, the health check result is “NG” when a permanent failure is detected and “OK” when a permanent failure is not detected. A time interval at which the health check processing is performed is not limited to one hour. The time interval at which the health check processing is executed may be set by a user.

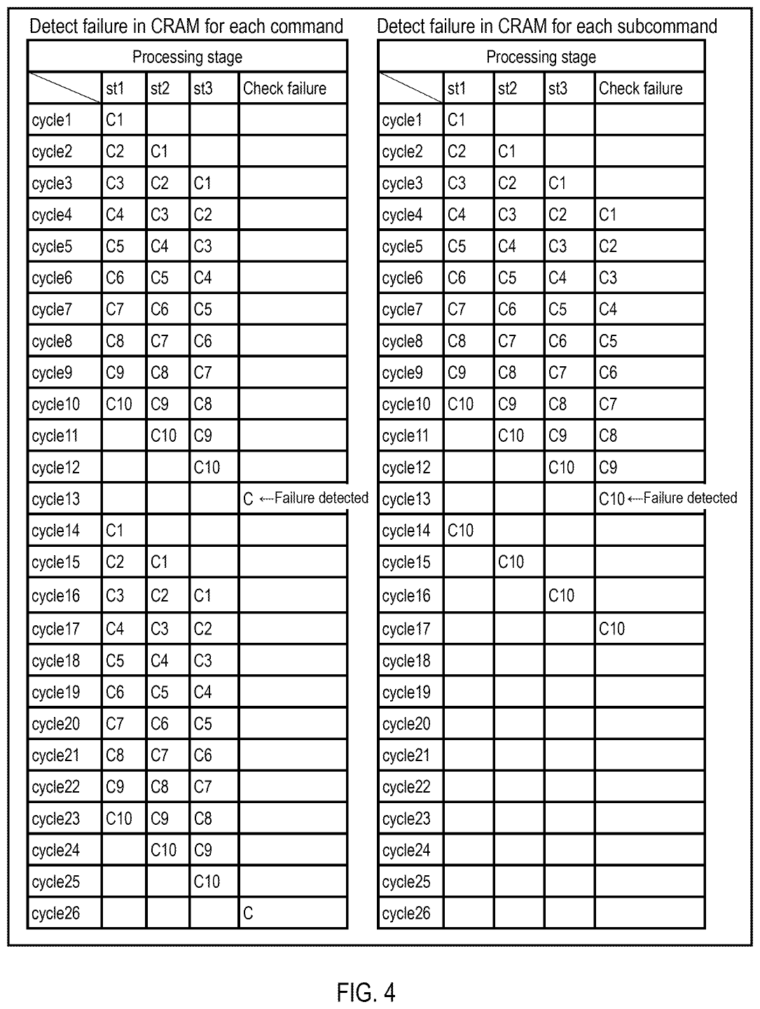

FIG. 4 is a diagram for describing an example of the second failure detection processing and is a diagram for comparing between a case (the left-side diagram) in which a failure of the CRAM 11 is detected by CRAM check processing for each command (for each FPGA processing) and a case (the right-side diagram) in which a failure of the CRAM 11 is detected by CRAM check processing for each subcommand (for each sub-processing) obtained by segmenting a command.

In the example illustrated in the drawing, a command is divided into ten subcommands, FPGA processing corresponding to the command is indicated by C, and the sub-processing steps corresponding to the subcommands are indicated by C1 to C10. The sub-processing steps C1 to C10 each include three processing stages st1 to st3. The sub-processing steps C1 to C10 are executed every cycle period for each processing stage sequentially from the sub-processing step C1. Moreover, different sub-processing step may be executed in a multiplexed manner as long as it occurs in different processing stages.

When a failure of the CRAM 11 is detected for each command, the cooperation unit 5 checks the presence of a failure of the CRAM 11 after the FPGA processing corresponding to the command ends completely. When a failure is present, because there is a possibility that the processing result of the FPGA processing is wrong, the cooperation unit 5 needs to execute the FPGA processing again. Therefore, when a failure is present, as illustrated in the left-side diagram, 26 cycle periods are required until the FPGA processing ends.

In contrast, when a failure of the CRAM 11 is detected for each subcommand, the cooperation unit 5 checks the presence of a failure of the CRAM 11 whenever a sub-processing step corresponding to the subcommand ends. When a failure is present, because the cooperation unit 5 may only need to execute the FPGA processing again from the sub-processing step in which the presence of a failure is detected, it is possible to shorten the time taken until the FPGA processing ends. For example, when a failure is detected when the sub-processing step C10 ends as in the drawing, because it is only necessary to execute the FPGA processing again from the sub-processing step C10, it is possible to end the FPGA processing in 17 cycle periods.

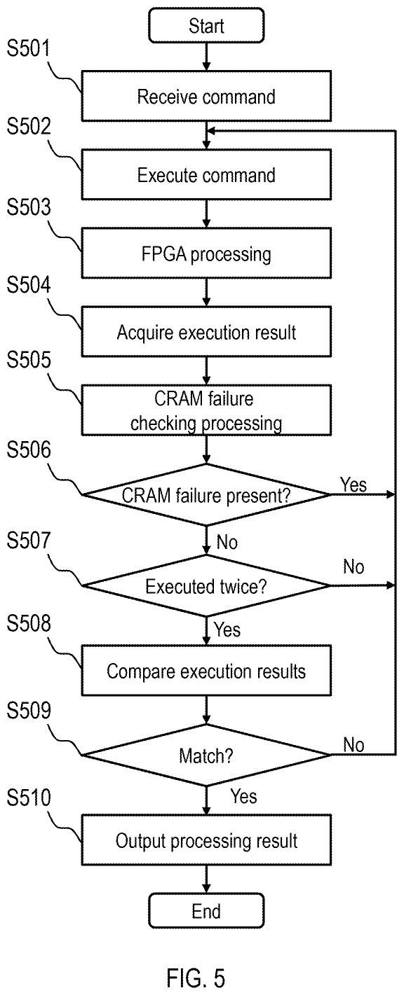

FIG. 5 is a flowchart for describing an operation of the computer system 100 related to the first failure detection processing and the second failure detection processing.

First, when the input query is a target query, the distribution DB engine 3 inputs a command corresponding to the query to the cooperation unit 5 via the I/F 4. The cooperation unit 5 receives the command (step S501).

The cooperation unit 5 executes the received command. That is, the cooperation unit 5 issues a plurality of subcommands corresponding to the received command and instructs the FPGA 1 to execute an FPGA processing for the received command and memory check processing (step S502).

The FPGA 1 executes FPGA processing and outputs an execution result thereof (step S503). The cooperation unit 5 acquires the execution result from the FPGA 1 (step S504).

The cooperation unit 5 executes CRAM failure checking processing of checking whether a failure of the CRAM 11 has been detected by the CRAM check processing (step S505). For example, the error detection unit 13 of the FPGA 1 performs the CRAM check processing repeatedly and outputs a failure notification of failure in the CRAM 11 to the cooperation unit 5 using interrupt processing or the like when a failure of the CRAM 11 is detected. The cooperation unit 5 checks whether a failure of the CRAM 11 is detected by checking whether a failure notification is output. When a failure has occurred, the error detection unit 13 executes correction processing of correcting the failure.

The cooperation unit 5 determines whether a failure of the CRAM 11 is detected in the CRAM failure checking processing (step S506).

When the failure of the CRAM 11 is detected, the flow returns to step S502. In this case, in step S502, the cooperation unit 5 issues a subcommand corresponding to a sub-processing step subsequent to the sub-processing step in which the failure of the CRAM 11 was detected.

When the failure of the CRAM 11 is not detected, the cooperation unit 5 determines whether the FPGA processing corresponding to the command received in step S502 has been executed twice (step S507).

When the FPGA processing has not been executed twice, the cooperation unit 5 returns to step S502. In contrast, when the FPGA processing has been executed twice, the cooperation unit 5 compares the execution results (step S508) and determines whether the execution results match each other (step S509).

When the execution results do not match each other, the cooperation unit 5 determines that an intermittent failure has occurred in the FPGA 1 and returns to step S502. In this case, the cooperation unit 5 initializes the number of execution times of the FPGA processing to 0 and executes the FPGA processing twice again.

In contrast, when the execution results match each other, the cooperation unit 5 determines that an intermittent failure has not occurred in the FPGA 1 and outputs the execution result to the distribution DB engine 3 via the I/F 4 as the processing result of the FPGA processing. The distribution DB engine 3 executes processing corresponding to the processing result (step S510) and ends the processing.

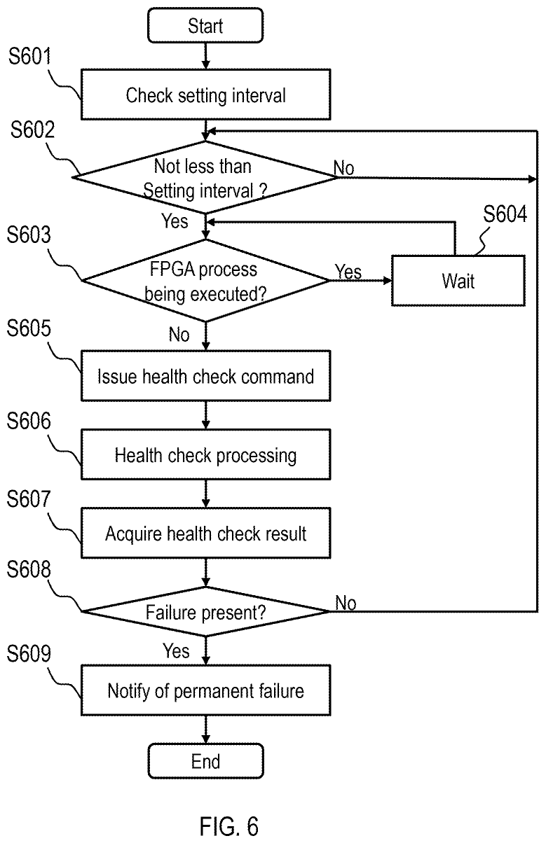

FIG. 6 is a flowchart for describing an operation of the computer system 100 related to the third failure detection processing.

The cooperation unit 5 checks a setting interval which is a time interval at which a health check command for requesting execution of health check processing is issued (step S601). The setting interval may be set in advance and may be set by a user.

The cooperation unit 5 determines whether the time elapsed after a previous health check command was issued is equal to or larger than the setting interval (step S602).

When the time elapsed after the health check command was issued is smaller than the setting interval, the cooperation unit 5 returns to step S602. In contrast, when the time elapsed after the health check command was issued is equal to or larger than the setting interval, the cooperation unit 5 checks whether the FPGA 1 is executing the FPGA processing (step S603).

When the FPGA processing is being executed, the cooperation unit 5 determines that the health check processing is not executable and waits for a predetermined period (step S604), and after that, the flow returns to step S603.

When the FPGA processing is not being executed, the cooperation unit 5 determines that the health check processing is executable and issues a health check command to the FPGA 1 (step S605). The health check command is preferably defined so that the permanent failures of circuits that form the FPGA 1 are comprehensively detected.

The FPGA 1 executes health check processing of checking whether circuits in the FPGA 1 are normal according to the issued health check command and outputs a health check result which is the processing result thereof (step S606).

The cooperation unit 5 acquires the health check result from the FPGA 1 (step S607). The cooperation unit 5 checks whether the health check result indicates that a failure is present in the FPGA 1 (step S608).

When a failure is not present, the cooperation unit 5 returns to step S602. In contrast, when a failure is present, the cooperation unit 5 outputs a permanent failure notification indicating occurrence of a failure to the distribution DB engine 3 via the I/F 4. The distribution DB engine 3 executes processing corresponding to the permanent failure notification (step S609) and ends the processing.

In the above-described operation, the cooperation unit 5 or the distribution DB engine 3 may update the history management table 300 according to the health check result.

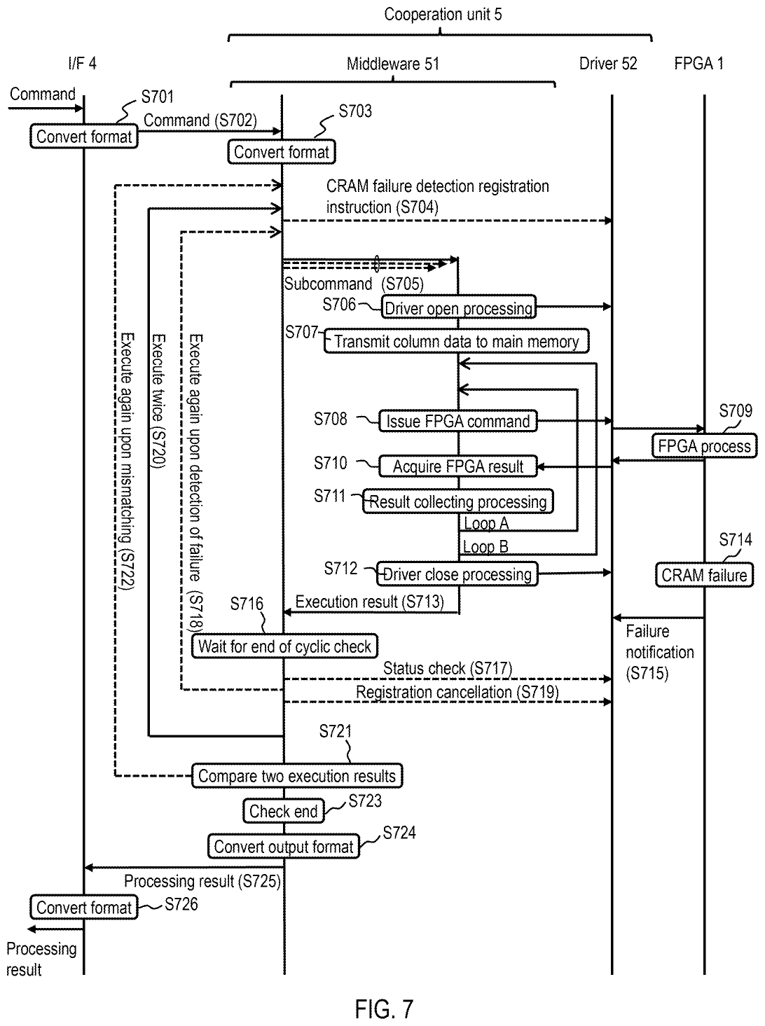

FIG. 7 is a sequence program for describing an operation of the computer system. 100 related to the first and second failure detection processing described in FIG. 5 in more detail. In FIG. 7, the cooperation unit 5 includes middleware 51 and a driver 52. Moreover, the storage apparatus 2 is described by way of an example in which the database is stored in the Parquet format, but the format of the database stored in the storage apparatus 2 is not limited to the Parquet format.

First, the I/F 4 receives a command from the distribution DB engine 3 and converts the command to a format corresponding to the cooperation unit 5 (step S701). The I/F 4 issues the command of which the format has been converted to the cooperation unit 5 (step S702). The middleware 51 of the cooperation unit 5 receives the command from the I/F 4 and converts the command to a format corresponding to the FPGA 1 (step S703).

The middleware 51 transmits a CRAM failure detection registration instruction for instructing transition to a registration state in which CRAM check processing is enabled for each of a plurality of subcommands obtained by segmenting a command to the driver 52. The driver 52 changes the valid/invalid flag of the state management table to “1” according to the CRAM failure detection registration instruction (step S704).

After that, the middleware 51 issues subcommands in a multiplexed manner (step S705).

The middleware 51 causes the FPGA 1 to execute the FPGA processing by causing the FPGA 1 to execute the sub-processing step sequentially on the basis of the issued subcommand (steps S706 to S713).

Specifically, first, the middleware 51 executes driver open processing to enable the driver 52 to access the FPGA 1 (step S706).

Subsequently, the middleware 51 transfers Parquet data processed by the FPGA processing from a database stored in the storage apparatus 2 to a main storage unit (not illustrated) (step S707).

The middleware 51 issues an FPGA command requesting the FPGA 1 to execute FPGA processing corresponding to the transmitted data to the driver 52. The driver 52 issues the FPGA command to the FPGA 1 (step S708). The FPGA 1 executes FPGA processing corresponding to the FPGA command and outputs the processing result thereof as an FPGA result (step S709). The driver 52 receives the FPGA result from the FPGA 1 and outputs the FPGA result to the middleware 51. The middleware 51 acquires the FPGA result (step S710). The middleware 51 executes result collecting processing of collecting the acquired FPGA results as an execution result of the FPGA processing (step S711).

The middleware 51 repeats the processing of steps S708 to S711 in units of Row groups (loop A). Moreover, the middleware 51 repeats the loop A in units of files of the Parquet format (loop B). When the loop B ends, the middleware 51 executes driver close processing of cancelling the state in which the driver 52 can access the FPGA 1 (step S712). The middleware 51 outputs an execution result finally obtained by the result collecting processing of step S711 (step S713).

The error detection unit 13 of the FPGA 1 executes the CRAM check processing repeatedly, and when a failure of the CRAM 11 is detected (step S714), outputs a failure notification to the driver 52 using interrupt processing. Upon receiving the failure notification, the driver 52 changes the CRAM failure status corresponding to the valid/invalid flag having “1” in the state management table being managed to “1” (step S715). Upon detecting the failure of the CRAM 11, the error detection unit 13 executes correction processing of correcting the failure.

After all subcommands are completed, the middleware 51 waits for a period until the cyclic check of the CRAM check processing ends (step S716). When the period elapses, the middleware 51 performs status check of inquiring the driver 52 about the CRAM failure status (step S717). When the inquiry result shows that any one of the CRAM failure status is “1”, the middleware 51 determines that a failure has occurred and returns to step S705 and issues a subcommand again (step S718). In this case, the middleware 51 issues a subcommand subsequent to a subcommand identified by an ID corresponding to the CRAM failure status having “1”.

When the inquiry result shows that all CRAM failure statuses are “0”, the middleware 51 transmits a cancellation instruction for instructing transition to an initial state to the driver 52. The driver 52 restores the state management table to the initial state according to the cancellation instruction (step S719). The middleware 51 checks whether or not the FPGA processing corresponding to the command from the I/F 4 has been executed twice and returns to step S705 (step S720) if the FPGA processing has not been executed twice.

When the FPGA processing has been executed twice, the middleware 51 compares the first execution result with the second execution result (step S721). When the execution results do not match each other, the middleware 51 initializes the number of execution times of the FPGA processing to 0 and returns to step S705 (step S722). The number of execution times of the FPGA processing is managed by the middleware 51, for example.

When the execution results match each other, the middleware 51 checks whether the entire processing corresponding to the command has ended (step S723), and when the entire processing has ended, converts the execution result to an output format (step S724) and outputs the same as a processing result (step S725). Upon receiving the processing result, the I/F 4 changes the processing result to the format of the distribution DB engine 3 and outputs the same to the distribution DB engine 3 (step S726) and ends the processing.

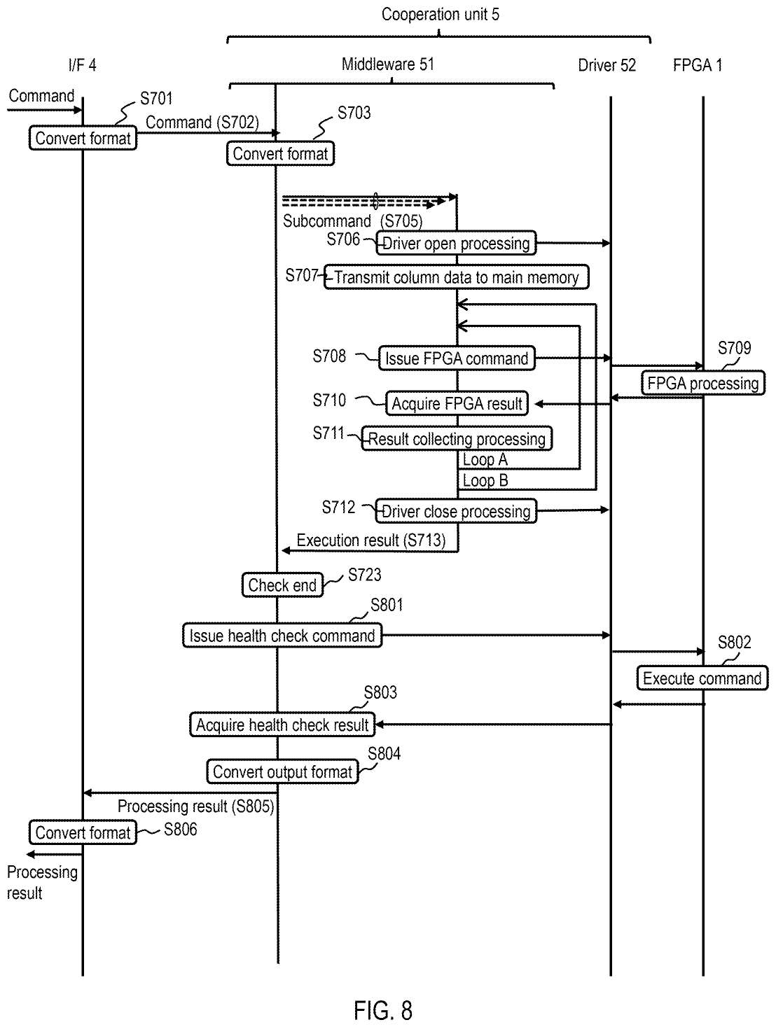

FIG. 8 is a sequence program for describing an operation of the computer system 100 related to the third failure detection processing described in FIG. 6 in more detail. Although the processing related to the first and second failure detection processing are omitted in FIG. 8, the third failure detection processing is consistent with the first and second failure detection processing. Moreover, FIG. 8 illustrates an example in which a timing for performing health check processing of the third failure detection processing has arrived during execution of the FPGA processing.

First, the processing of steps S701 to S703, S705 to S713, and S723 are executed. When it is determined in step S723 that the entire processing corresponding to the command have ended, the middleware 51 issues a health check command to the driver 52. The driver 52 outputs a health check command to the FPGA 1 (step S801). The FPGA 1 executes health check processing corresponding to the health check command and outputs a health check result which is the processing result thereof (step S802). The driver 52 receives the health check result from the FPGA 1 and outputs the health check result to the middleware 51. The middleware 51 acquires the health check result (step S803).

The middleware 51 converts the execution result and the health check result to output formats (step S804) and outputs the same as a processing result (step S805). Upon receiving the processing result, the I/F 4 changes the processing result to the format of the distribution DB engine 3, outputs the same to the distribution DB engine 3 (step S806), and ends the processing.

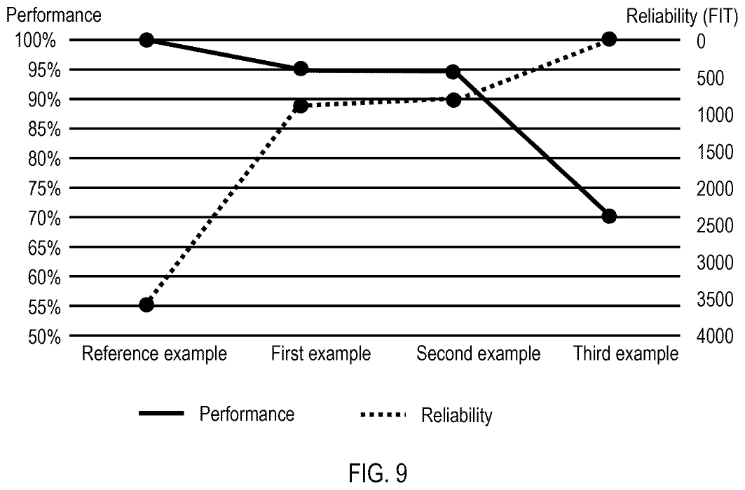

FIG. 9 is a diagram for describing the degree of improvement in reliability and the degree of influence on performance by failure detection processing. FIG. 9 illustrates the reliability and the performance in a reference example in which failure detection processing is not performed, a first example in which the second failure detection processing only is performed, a second example in which the second and third failure detection processing are performed, and a third example in which all the first to third failure detection processing are performed. Specifically, the reliability is FIT (Failure In Time) which is a failure rate index. The performance is a processing speed, for example, and the value of a reference example in which failure detection processing is not performed is set to 100%. Moreover, the solid line indicates performance and the dot line indicates reliability.

As illustrated in FIG. 9, when the second failure detection processing only is performed, the reliability is very high and the degree of influence on performance is low as compared to those of the reference example. When the first and third failure detection processing are performed in addition to the second failure detection processing, the reliability can be improved further. In contrast, the performance decreases a little. A user may select failure detection processing to be executed among the first to third failure detection processing by taking reliability and performance into consideration.

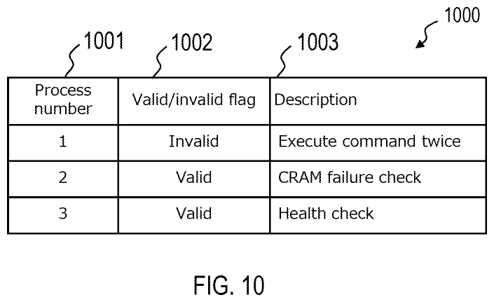

FIG. 10 is a diagram illustrating an example of setting information indicating failure detection processing to be executed. The setting information is recorded on a recording medium (not illustrated) or the like, for example, and is managed by the cooperation unit 5.

Setting information 1000 illustrated in FIG. 10 has a processing number 1001, a valid/invalid flag 1002, and a description 1003. The processing number 1001 is a field for recording a processing number which is identification information for identifying failure detection processing. In the processing number, the first failure detection processing is “1”, the second failure detection processing is “2”, and the third failure detection processing is “3”. The valid/invalid flag 1002 is a field for recording an execution flag indicating whether or not failure detection processing will be executed. The execution flag is “valid” when failure detection processing is executed and is “invalid” when failure detection processing is not executed. The description 1003 is a field for recording an explanatory note which is character information for describing the content of failure detection processing. The explanatory note indicates at least one of a method and a function of detecting failures.

The computer system 100 may display a screen for changing setting information on a display device (not illustrated) provided in the computer system 100 or coupled to the computer system 100. When an instruction to change setting information is input, the computer system 100 changes the setting information of the cooperation unit 5 according to the instruction. The cooperation unit 5 executes failure detection processing on the basis of the setting information.

In the above-described embodiment, although the FPGA 1 is used as an accelerator of storage processing, the use of the FPGA 1 is not limited to this example. Moreover, those other than FPGA may be used as the programmable device.

As described above, the present disclosure includes the following matters.

A computer system 100 according to an aspect of the present disclosure includes a programmable device 1 and a control unit 6. The programmable device includes a memory 11 that records configuration data for defining a circuit configuration, a main circuit unit 12 of which the circuit configuration is determined according to the configuration data, and an error detection unit 13 that executes memory check processing whether or not any error is present in the configuration data. The control unit is configured to cause the main circuit unit to sequentially execute a plurality of sub-processing steps obtained by segmenting predetermined processing upon receiving a query requesting execution of the predetermined processing to execute the predetermined processing and enable the error detection unit to execute the memory check processing for each of the sub-processing steps.

Due to the above-described matters, because memory check processing is enabled for each of the sub-processing steps obtained by segmenting predetermined processing required by the query, it is possible to detect a failure in the course of predetermined processing. Moreover, it is not necessary to simplify memory check processing. Therefore, it is possible to secure reliability while decreasing the time required for detecting failures.

The memory check processing includes correction processing of correcting an error when the configuration data has an error. The control unit is configured to cause the main circuit unit to execute the predetermined processing again, starting with a sub-processing step corresponding to memory check processing that has detected the presence of the error when an error was detected in the memory check processing. Therefore, because it is not necessary to execute the predetermined processing from the start again when a failure occurs, it is possible to shorten the processing execution time.

The control unit is configured to cause the main circuit unit to execute the predetermined processing twice and compares execution results to detect presence of a failure in the programmable device. Therefore, because it is possible to detect an intermittent failure other than a failure in the configuration data, it is possible to improve reliability further.

The control unit is configured to determine that the programmable device has a failure when the execution results do not match and causes the main circuit unit to execute the predetermined processing twice again. Therefore, because it is possible to prevent a wrong processing result from being returned, it is possible to improve reliability further.

The control unit is configured to periodically perform health check processing of checking whether circuits in the programmable device are normal. Therefore, because it is possible to check the presence of a permanent failure periodically, it is possible to improve reliability further.

The programmable device is an FPGA. Therefore, even when the programmable device is an FPGA, it is possible to secure reliability while decreasing the time required for detecting failures.

The above-described embodiment of the present disclosure is an example for describing the present disclosure and the scope of the present disclosure is not limited to the embodiment only. Those skilled in the art can implement the present invention in various other forms without departing from the scope of the present invention.

What is claimed is:

1. A computer system comprising:
a programmable device including a memory that records configuration data for defining a circuit configuration, a main circuit unit of which the circuit configuration is determined according to the configuration data, and an error detection unit that executes memory check processing of detecting whether or not any error is present in the configuration data; and
a control unit is configured to cause the main circuit unit to sequentially execute a plurality of sub-processing steps obtained by segmenting predetermined processing upon receiving a query requesting execution of the predetermined processing to execute the predetermined processing and enable the memory check processing for each of the sub-processing steps.

2. The computer system according to claim 1, wherein
the memory check processing includes correction processing of correcting an error when the configuration data has an error, and
the control unit is configured to cause the main circuit unit to execute the predetermined processing again, starting with a sub-processing step corresponding to memory check processing that has detected the presence of the error when an error was detected in the memory check processing.

3. The computer system according to claim 1, wherein
the control unit is configured to cause the main circuit unit to execute the predetermined processing twice and compares execution results to detect presence of a failure in the programmable device.

4. The computer system according to claim 3, wherein
the control unit is configured to determine that the programmable device has a failure when the execution results do not match and causes the main circuit unit to execute the predetermined processing twice again.

5. The computer system according to claim 1, wherein
the control unit is configured to periodically perform health check processing of checking whether circuits in the programmable device are normal.

6. The computer system according to claim 1, wherein
the programmable device is an FPGA (Field-Programmable Gate Array).

7. A control method of a computer system including a programmable device including a memory that records configuration data for defining a circuit configuration, a main circuit unit of which the circuit configuration is determined according to the configuration data, and an error detection unit that executes memory check processing of detecting whether or not any error is present in the configuration data, the method comprising:
causing the main circuit unit to sequentially execute a plurality of sub-processing steps obtained by segmenting predetermined processing upon receiving a query requesting execution of the predetermined processing to execute the predetermined processing; and
enabling the memory check processing for each of the sub-processing steps.

8. A Non-transitory computer readable medium recoding a program for causing a computer coupled to a programmable device including a memory that records configuration data for defining a circuit configuration, a main circuit unit of which the circuit configuration is determined according to the configuration data, and an error detection unit that executes memory check processing of detecting whether or not any error is present in the configuration data, the computer executing:
a procedure of causing the main circuit unit to sequentially execute a plurality of sub-processing steps obtained by segmenting predetermined processing upon receiving a query requesting execution of the predetermined processing to execute the predetermined processing; and
a procedure of enabling the memory check processing for each of the sub-processing steps.
